(19) United States
(12) Patent Application Publication
(10) Pub. No.: US 2011/0294027 A1
(43) Pub. Date: Dec. 1, 2011

(54) FUEL CELL SYSTEM AND A METHOD FOR CONTROLLING THE FUEL CELL SYSTEM

(75) Inventor: Kenji Kibune, Kobe-shi (JP)

(73) Assignee: SANYO Electric Co., Ltd.

(21) Appl. No.: 13/116,678

(22) Filed: May 26, 2011

(30) Foreign Application Priority Data
May 27, 2010 (JP) 2010-121788
Mar. 28, 2011 (JP) 2011-070761

(51) Int. Cl. H01M 8/04

(52) U.S. Cl. 429/443

(57) ABSTRACT

A fuel cell system includes (1) a fuel containing unit having two containers containing a metal hydride, the two containers being disposed in thermal contact with each other, (2) a fuel cell disposed in thermal contact with one of the two containers, (3) a discharge regulating valve capable of switching between a suppressed state in which hydrogen discharge from the other of the two containers is suppressed and an open state in which the suppressed state is canceled, and (4) a control unit for controlling the discharge regulating valve so that the suppressed state is set when the temperature inside the other container is less than a predetermined temperature and the open state is set when the temperature inside the other container is greater than or equal to the predetermined temperature.

This application is based upon and claims the benefit of priority from the prior Japanese Patent Applications No. 2010-121788, filed on May 27, 2010 and No. 2011-070761, filed on Mar. 28, 2011, the entire contents of both of which are incorporated herein by reference.

### BACKGROUND OF THE INVENTION

1. Field of the Invention

The present invention relates to a fuel cell system and a method for controlling said fuel cell system.

2. Description of the Related Art

A fuel cell system is a device that generates electricity from hydrogen and oxygen so as to obtain highly efficient power generation. A principal feature of the fuel cell system is its capacity for direct power generation which does not undergo a stage of thermal energy or kinetic energy as in the conventional power generation. This presents such advantages as high power generation efficiency despite the small scale setup, reduced emission of nitrogen compounds and the like, and environmental friendliness on account of minimal noise or vibration. In this manner, the fuel cell system is capable of efficiently utilizing chemical energy in its fuel and, as such, environmentally friendly. The fuel cell system is therefore expected as an energy supply system for the twenty-first century and have gained attention as a promising power generation system that can be used in a variety of applications including space applications, automobiles, mobile devices, and large and small scale power generation. Serious technical efforts are being made to develop a practical fuel cell system.

Conventionally known are (i) a container, provided separately from a fuel cell body, for holding hydrogen serving as fuel gas and (ii) a fuel cell system equipped with this container. The container for holding hydrogen is provided with a metal hydride (hydrogen storage alloy) capable of storing and discharging hydrogen, for instance. In this container, hydrogen is stored into the metal hydride, so that hydrogen can be held inside the container. Also, hydrogen is discharged from the metal hydride, so that hydrogen can be supplied to the fuel cells.

The metal hydride generates heat when hydrogen is absorbed, and the metal hydride absorbs the heat when hydrogen is discharged. Accordingly, it is desirable that the heat required for the discharging of hydrogen be efficiently supplied to the metal hydride in order to stably supply hydrogen from the container to the fuel cell. The fuel cell is provided with an electrolyte membrane, an anode catalyst layer, and a cathode catalyst layer. And the anode catalyst layer and the cathode catalyst layer are disposed counter to each other with the electrolyte membrane interposed therebetween. The fuel cell generates DC power through an electrochemical reaction by way of the electrolyte membrane by supplying hydrogen to the anode side and air to the cathode side. This electrochemical reaction is an exothermic reaction. Thus, if the heat generated through the electrochemical reaction in the fuel cell is to be utilized as the heat required for the discharging of hydrogen in the metal hydride, the heat supply efficiency can be improved and therefore hydrogen can be stably supplied to the fuel cell. In contrast thereto, there is room for improvement of stability in supplying hydrogen to the fuel cell.

### SUMMARY OF THE INVENTION

The present invention has been made in view of the foregoing problems, and a purpose thereof is to provide a technology capable of stably supplying hydrogen to a fuel cell.

One embodiment of the present invention relates to a fuel cell system. The fuel cell system includes: a fuel containing unit having at least two containers containing a metal hydride storing hydrogen to be supplied to a fuel cell, the two containers being disposed in thermal contact with each other; a fuel cell disposed in thermal contact with one of the two containers; a discharge regulating unit capable of switching between a suppressed state in which hydrogen discharge from the other of the two containers is suppressed and an open state in which the suppressed state is canceled; and a control unit configured to control the discharge regulating unit according to information from a temperature detector for detecting temperature inside the other of the containers such that the suppressed state is set when the temperature inside the other container is less than a predetermined temperature and the open state is set when the temperature inside the other container is greater than or equal to the predetermined temperature.

In the above-described embodiment, the fuel containing unit may have at least a first to a third container, which are disposed such that the first container and the second container are in outermost positions with the third container disposed therebetween in thermal contact therewith; the fuel cell may be a pair of fuel cells of which one is disposed in thermal contact with the first container and the other in thermal contact with the second container; the discharge regulating unit may be capable of switching between the suppressed state in which hydrogen discharge from the third container is suppressed and the open state in which the suppressed state is canceled; and the control unit may control the discharge regulating unit according to information from a temperature detector for detecting temperature inside the third container such that the suppressed state is set when the temperature inside the third container is less than a predetermined temperature and the open state is set when the temperature inside the third container is greater than or equal to the predetermined temperature.

In the above-described embodiment, the fuel cell system may further include: a distribution flow path configured to supply hydrogen from the third container to at least one of the first container and the second container; and a flow path switch configured to switch between a main flow path for supplying hydrogen from the third container to the fuel cell and the distribution flow path, wherein the control unit may control the flow path switch in such a manner as to effect switching from the main flow path to the distribution flow path after the stoppage of fuel cell operation. After the internal pressures of the first to third contains have been averaged, the control unit may control the flow path switch in such a manner as to effect switching from the distribution flow path to the main flow path where a flow of hydrogen to said fuel cell is shut off.

In the above-described embodiment, the third container may be larger in volumetric capacity than the first container and the second container.

Another embodiment of the present invention relates to a method for controlling a fuel cell system. This method controls a fuel cell system that includes (i) a fuel containing unit having at least two containers containing a metal hydride storing hydrogen to be supplied to a fuel cell, the two containers being disposed in thermal contact with each other and (ii) a fuel cell disposed in thermal contact with one of the two container, and the method is such that hydrogen discharge from the other of the two containers is suppressed when the temperature inside the other container is less than a predetermined temperature, and the suppression of hydrogen discharge from the other of the two containers is canceled when the temperature inside the other container is greater than or equal to the predetermined temperature.

Still another embodiment of the present invention relates also to a method for controlling a fuel cell system. This method controls a fuel cell system that includes (i) a fuel containing unit having at least a first container to a third container containing a metal hydride storing hydrogen to be supplied to a fuel cell, which are disposed such that the first container and the second container are in outermost positions with the third container disposed therebetween in thermal contact therewith, and (ii) a pair of fuel cells of which one is disposed in thermal contact with the first container and the other in thermal contact with the second container, and the method is such that hydrogen discharge from the third container is suppressed when the temperature inside the third container is less than a predetermined temperature, and the suppression of hydrogen discharge from the third container is canceled when the temperature inside the third container is greater than or equal to the predetermined temperature.

In the above-described embodiment, hydrogen may be supplied from the third container to at least one of the first container and the second container after the stoppage of fuel cell operation. After the internal pressures of the first to third contains have been averaged, supplying hydrogen from the third container to at least one of the first container and the second container may be stopped.

It is to be noted that any arbitrary combinations or rearrangement, as appropriate, of the aforementioned constituting elements and so forth are all effective as and encompassed by the embodiments of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a schematic perspective illustration showing an appearance of a fuel cell system according to a first embodiment;

FIG. 2A is a schematic perspective illustration of a fuel cell system with a control unit cover removed;

FIG. 2B is a schematic perspective illustration of a neighborhood of hydrogen charging inlets of a fuel cell system with a hydrogen charging inlet cover removed;

FIG. 3 is a schematic perspective illustration of a fuel cell system with a control unit and a piping unit cover both removed;

FIG. 4 is a schematic cross-sectional view taken along the line A-A of FIG. 3;

FIG. 5 is a schematic cross-sectional view taken along the line B-B of FIG. 4;

FIGS. 6A and 6B are schematic diagrams for explaining an operation control for a fuel cell system according to a first embodiment;

FIG. 7 is a flowchart for controlling a fuel cell system according to a first embodiment;

FIG. 8 is schematic perspective illustration of a fuel cell system according to a second embodiment with a control unit and a piping unit cover both removed;

FIGS. 9A to 9C are conceptual diagrams to explain an operation control of a fuel cell system according to a second embodiment;

FIG. 10 is a flowchart for controlling a fuel cell system according to a second embodiment;

FIG. 11 is a horizontal sectional view schematically showing a structure of a fuel cell system according to a third embodiment;

FIG. 12 is a vertical sectional view schematically showing a structure of a fuel cell system according to a third embodiment;

FIGS. 13A and 13B are conceptual diagrams to explain an operation control of a fuel cell system according to a third embodiment; and

FIG. 14 is a conceptual diagram to explain a structure of a fuel cell system according to a modification.

### DETAILED DESCRIPTION OF THE INVENTION

The invention will now be described by reference to the preferred embodiments. This does not intend to limit the scope of the present invention, but to exemplify the invention.

The same or equivalent constituents, members, or processes illustrated in each drawing will be denoted with the same reference numerals, and the repeated descriptions thereof will be omitted as appropriate. The preferred embodiments do not intend to limit the scope of the invention but exemplify the invention. All of the features and the combinations thereof described in the embodiments are not necessarily essential to the invention.

### First Embodiment

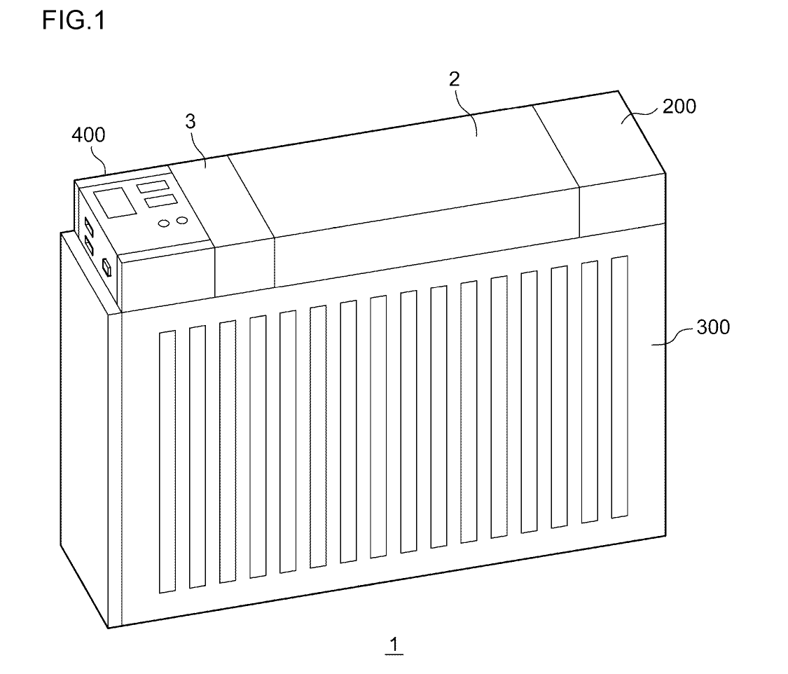

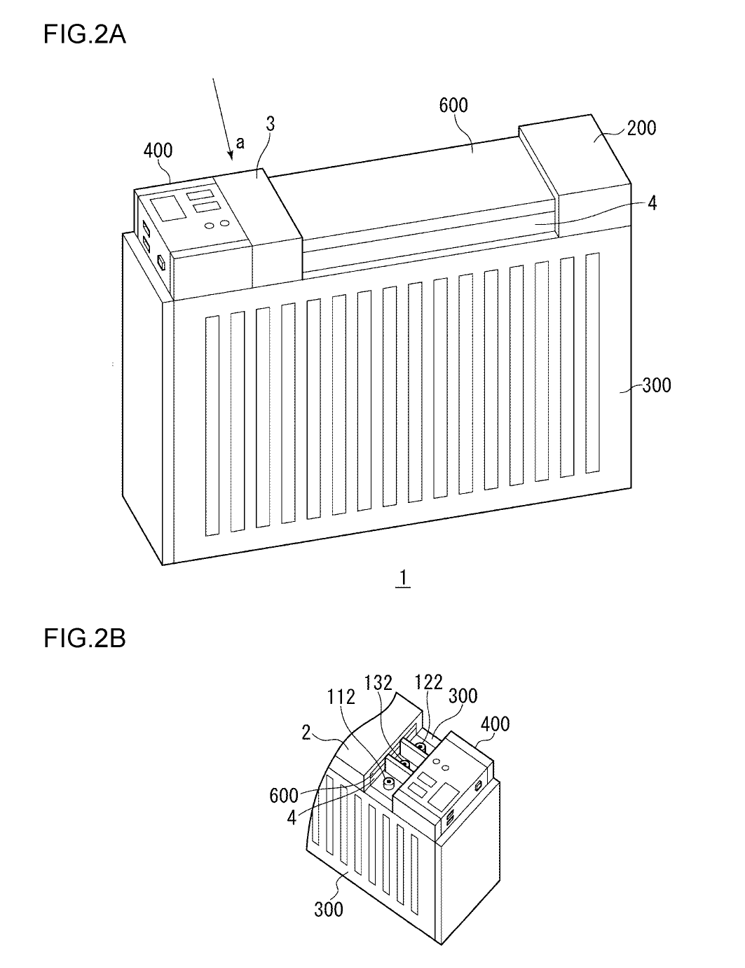

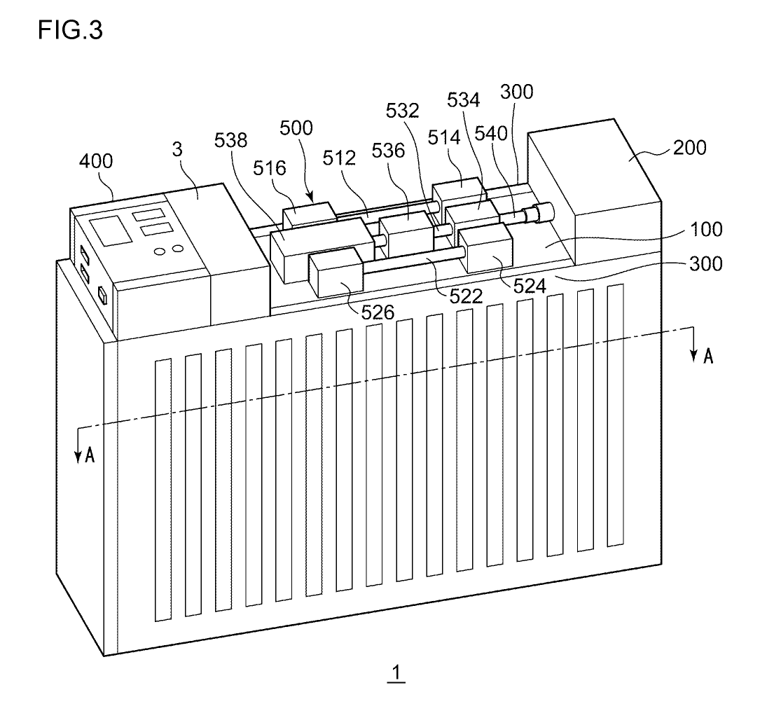

Referring to FIG. 1 to FIG. 3, a description will be given of a principal structure of a fuel cell system according to a first embodiment of the present invention. FIG. 1 is a schematic perspective illustration showing the appearance of a fuel cell system according to the first embodiment. FIG. 2A is a schematic perspective illustration of the fuel cell system with a control unit cover removed, whereas FIG. 2B is a schematic perspective illustration of a neighborhood of hydrogen charging inlets of the fuel cell system with a hydrogen charging inlet cover removed. Note that FIG. 2B is an illustration of part of the fuel cell system viewed from a direction indicated by arrow “a” in FIG. 2A. FIG. 3 is a schematic perspective illustration of the fuel cell system with a control unit and a piping unit cover both removed.

The fuel cell system 1 according to the first embodiment includes a fuel containing unit 100 (fuel containers), a regulator unit 200, a pair of fuel cells 300, an operation display unit 400, a piping unit 500, and a control unit 600 as principal components. The fuel containing unit 100 is a flat rectangular parallelepiped, and a pair of approximately plate-like fuel cells 300 is disposed such that the fuel containing unit 100 is interposed between them. The pair of fuel cells 300 is so disposed that one of the pair of fuel cells 300 is in contact with one of the two main opposing surfaces of the fuel containing unit 100, and the other in contact with the other of the two main surfaces of the fuel containing unit 100.

The operation display unit 400 is disposed on the upper surface of the fuel containing unit 100 and at one end thereof. Also, provided adjacent to the operation display unit 400 are hydrogen charging inlets 112, 122, and 132 respectively for a first to a third container to be described later. The hydrogen charging inlets 112, 122 and 132 may be covered by a hydrogen charging inlet cover 3 which is removable. Also, the regulator unit 200 is disposed on the upper surface of the fuel containing unit 100 and at the other end thereof. Further, provided on the upper surface of the fuel containing unit 100 is the piping unit 500 which connects hydrogen discharging outlets (not shown) of the first to third containers to the regulator unit 200. The piping unit 500 may be covered by a piping unit cover 4 which is removable. The control unit 600 is disposed on the upper surface of the piping unit cover 4 covering the piping unit 500. The control unit 600 may be covered by a control unit cover 2 which is removable. The control unit cover 2 is so constructed as to cover the control unit 600 and the piping unit cover 4 covering the piping unit 500.

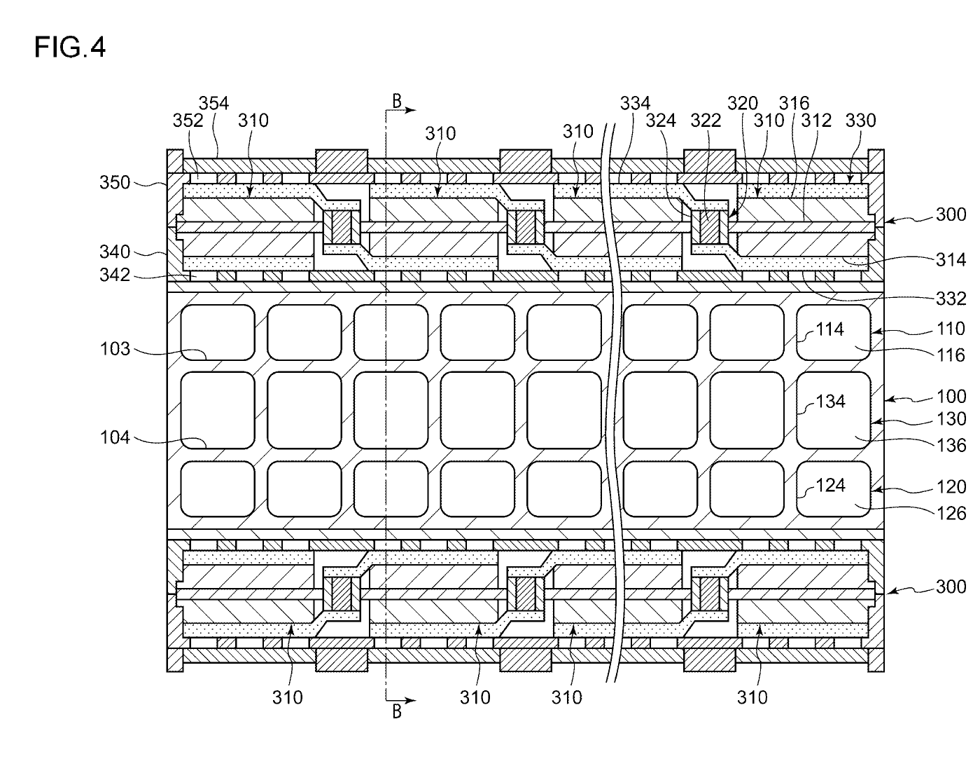

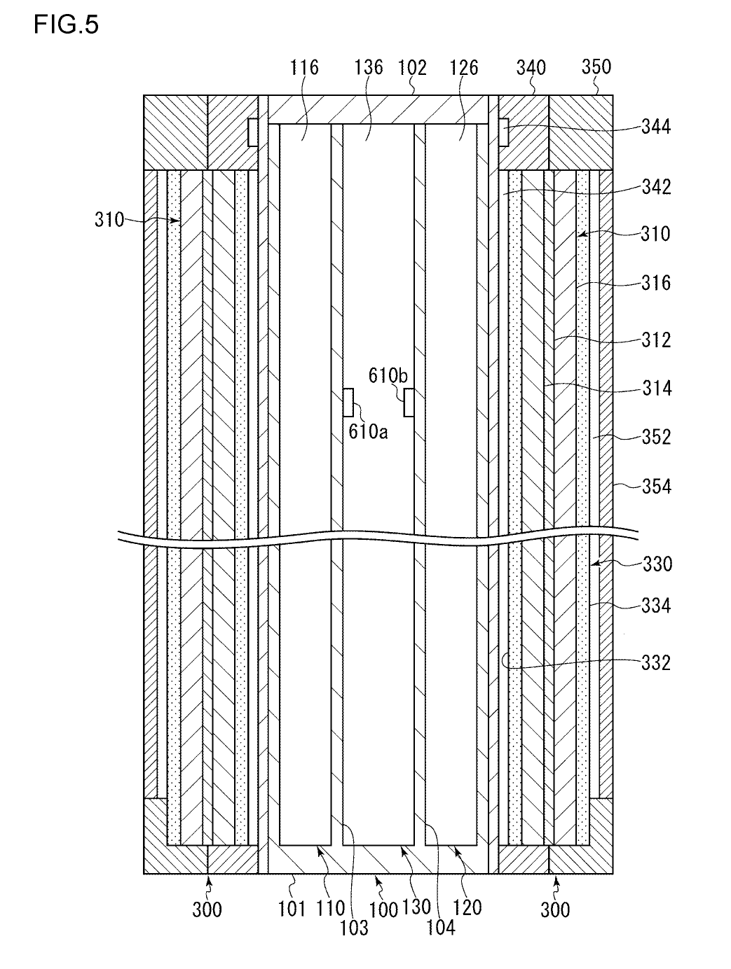

Next, a detailed description will be given of the constitutions of the respective components. FIG. 4 is a schematic cross-sectional view taken along the line A-A of FIG. 3. FIG. 5 is a schematic cross-sectional view taken along the line B-B of FIG. 4. It is to be noted, however, that an outer casing of the fuel cell system 1 is not shown in FIG. 4 and FIG. 5.

As shown in FIG. 4 and FIG. 5, the fuel containing unit 100 has a first container 110, a second container 120, and a third container 130 each containing a metal hydride (hydrogen storage alloy) storing hydrogen to be supplied to a pair of fuel cells 300. The first container 110 and the second container 120 are disposed in outermost positions of the fuel containing unit 100. The third container 130 is disposed between the first container 110 and the second container 120 in thermal contact therewith.

In the first embodiment, the fuel containing unit 100 includes a container section 101 and a lid section 102. The container section 101 has an interior divided into three chambers by a partition 103 and a partition 104, which extend approximately parallel to the main surfaces of the fuel containing unit 100 from the upper surface thereof, where the piping unit 500 and the like are disposed, down to the lower surface disposed counter to the upper surface thereof. And the two outer chambers constitute the first container 110 and the second container 120, and the middle chamber the third container 130. Each container is made airtight against each other by the partitions 103 and 104. Also, the third container 130 is larger in volumetric capacity than the first container 110 and the second container 120.

Attached to the partitions 103 and 104 are temperature sensors (temperature detecting units) 610a and 610b, respectively, for detecting the temperature inside the third container 130. Thermocouples, for instance, may be used as the temperature sensors 610a and 610b. In the first embodiment, the temperature sensor 610a is provided to detect the wall surface temperature T1 of the partition 103, and the temperature sensor 610b to detect the wall surface temperature T2 of the partition 104. The detected values of the temperature sensors 610a and 610b are transmitted to the control unit 600, so that the control unit 600 can estimate the temperature inside the third container 130 from the wall surface temperatures T1 and T2. Note that the detection of the temperature inside the third container 130 is not limited to this arrangement, but the arrangement may also be such that the temperature sensors 610a and 610b are disposed in the middle of the third container 130 to measure the temperature of the metal hydride in the third container 130 directly. Also, while two temperature sensors are provided in the first embodiment, the number of temperature sensors is not limited thereto, but it can be changed as appropriate depending on the required accuracy of temperature detection, the performance of the temperature sensors, and the like.

The lid section 102, which is so disposed as to cover the openings of the container section 101, constitutes the top surface of the fuel containing unit 100. The regulator unit 200, the operation display unit 400, and the piping unit 500 are placed on the lid section 102. The lid section 102 is provided with the hydrogen charging inlets 112, 122, and 132 (see FIG. 2B) and hydrogen discharging outlets (not shown) in positions corresponding to the respective containers.

The first container 110 is provided with a plurality of partitions 114 which are approximately perpendicular to the main surface of the fuel containing unit 100 and extend from the upper surface to the lower surface of the fuel containing unit 100. The first container 110 has an interior divided into a plurality of small chambers 116 by the plurality of partitions 114. A metal hydride (not shown) is held in each of the small chambers 116. The partitions 114 are each provided with a through hole (not shown) at a predetermined position. Thus the small chambers 116 are communicated with each other via the through holes in the partitions 114. Similarly, the second container 120 and the third container 130 have each an interior divided into a plurality of small chambers 126 and 136, respectively, by a plurality of partitions 124 and 134, respectively. A metal hydride is held in each of the small chambers 126 and 136. The partitions 124 and 126 are each provided with a through hole (not shown) by which the small chambers 126 and 136, respectively, are communicated with each other.

The hydrogen charging inlets 112, 122 and 132 provided in the lid section 102 are communicated at one end thereof with the first container 110, the second container 120, and the third container 130, respectively. Hydrogen can be injected into each of the containers by connecting charging hoses from a hydrogen filling unit (not shown) to the hydrogen charging inlets 112, 122 and 132. The hydrogen injected into the first to third containers 110, 120 and 130 passes through the through holes in the partitions 114, 124 and 134 and reaches each of the small chambers 116, 126 and 136, where the injected hydrogen is stored in the metal hydride held therein. Also, the hydrogen discharging outlets (not shown) for the respective containers provided in the lid section 102 are communicated at the other end thereof with the piping unit 500. The hydrogen released from the metal hydride held in each of the small chambers 116, 126 and 136 moves through the small chambers passing through the through holes in the partitions 114, 124 and 134 of the containers and reaches the hydrogen discharging outlets, through which the hydrogen released therefrom is sent from the respective containers to the piping unit 500.

The metal hydride, which can store hydrogen and can release the stored hydrogen, is rare-earth Mm (misch metal) Ni_{4.32}Mn_{0.18}Al_{0.1}Fe_{0.1}Cu_{0.3}, for instance. Note that the hydrogen storage alloy is not limited to a rare-earth-based alloy, but may include a Ti—Mn, Ti—Fe, Ti—Zr, Mg—Ni, or Zr—Mn based alloy, for instance. More specifically, the metal hydride may be LaNi₅ alloy, Mg₂Ni alloy, or Ti₁₊ₓCr_{2-y}Mn_{y} (x=0.1 to 0.3, y=0 to 1.0) alloy, for instance. The metal hydride may be prepared such that the powder of the aforementioned metal hydride is mixed with a binder such as polytetrafluoroethylene (PTFE) dispersion and this mixture is made into pellets compressed and formed by a pressing machine. These pellets may undergo a sintering process as necessary.

As shown in FIG. 3, the hydrogen sent out from the fuel containing unit 100 passes through the piping unit 500 and goes to the regulator unit 200. The piping unit 500 has pipings 512, 522 and 532, which extend substantially parallel to each other, and a collecting pipe 540. The piping 512 constitutes a flow path for hydrogen sent out from the first container 110, the piping 522 that for hydrogen sent out from the second container 120, and the piping 532 that for hydrogen sent out from the third container 130. The pipings 512 and 522 are provided along the way with joints 514 and 524, respectively. The ends of the pipings 512 and 522 closer to the regulator unit 200 extend toward the piping 532 via the joints 514 and 524, respectively. A joint 534 is provided at an end of the piping 532 closer to the regulator unit 200. Connected to the joint 534 are the pipings 512 and 522 and one end of the collecting pipe 540. The other end of the collecting pipe 540 is connected to the regulator unit 200. Thus the hydrogen sent out from the first to third containers 110, 120 and 130 flows through the pipings 512, 522 and 532, respectively, and, after joining together at the joint 534, is sent to the regulator unit 200 through the collecting pipe 540.

The piping 512 is provided midway with a check valve 516, the piping 522 with a check valve 526, and the piping 532 with a check valve 536. The check valves 516, 526 and 536 prevent the reverse flow of hydrogen from the fuel cell 300 to the fuel containing unit 100. Also, the piping 532 is provided midway with a discharge regulating valve 538 (discharge regulating unit) on the side closer to the third container 130 than the check valve 536. The discharge regulating valve 538 is a component capable of switching between a suppressed state in which hydrogen discharge from the third container is suppressed and an open state in which the suppressed state is canceled. A throttle valve or an on-off valve, for instance, may be used as the discharge regulating valve 538. When the discharge regulating valve 538 is a throttle valve, the arrangement may be such that the suppressed state is created by a fully throttled state of the valve, and the open state by a less throttled state thereof. Also, in this case, the arrangement may be such that the hydrogen discharge in the suppressed state is either zero or a little in order to supplement the hydrogen supply to the fuel cell 300. When the discharge regulating valve 538 is an on-off valve, the arrangement may be such that the suppressed state is created by a closed state of the valve, and the open state by an opened state thereof.

The regulator unit 200 includes a hydrogen supply path and a regulator (both not shown) as the main components thereof. One end of the hydrogen supply path is communicated with the collecting pipe 540 of the piping unit 500, and the other end thereof with a pair of fuel cells 300. The regulator is provided at a position midway on the hydrogen supply path. The regulator reduces the pressure of hydrogen supplied to the pair of fuel cells 300 when hydrogen is supplied from an external cylinder to the metal hydride or when hydrogen is discharged from the metal hydride. In this manner, the anode catalyst layer of the fuel cell 300 is protected.

As shown in FIG. 4 and FIG. 5, the pair of fuel cells 300 is so disposed that one of them is in thermal contact with the first container 110 and the other with the second container 120. In the present embodiment, one of the fuel cells 300 is in contact with the main surface on the first container 110 side of the fuel containing unit 100, and the other of the fuel cells 300 is in contact with the main surface on the second container 120 side of the fuel containing unit 100. The pair of fuel cells 300 is so arranged that the side face on the anode side of each of the fuel cells 300 is touching the fuel containing unit 100.

The fuel cells 300, which are both of the same structure, include each a plurality of membrane electrode assemblies (MEAs) 310 arranged in a plane, interconnectors 320, current collecting members 330, an anode housing 340, and a cathode housing 350 as the main components thereof.

Each of the MEAs 310 has (1) an electrolyte membrane 312, (2) an anode catalyst layer 314, which is disposed on one of the surfaces of the electrolyte membrane 312, and (3) a cathode catalyst layer 316, which is disposed on the other of the surfaces of the electrolyte membrane 312 in opposition to the anode catalyst layer 314. Each of the MEAs 310 is disposed to extend in the same direction as the extension direction of each container (direction of the extension of the fuel containing unit 100 from the top to the bottom thereof).

The electrolyte membrane 312, which preferably shows excellent ion conductivity in a moist condition, functions as an ion-exchange membrane for the transfer of protons between the anode catalyst layer 314 and the cathode catalyst layer 316. The electrolyte membrane 312 is formed of a solid polymer material such as a fluorine-containing polymer or a nonfluorine polymer. The material that can be used is, for instance, a sulfonic acid type perfluorocarbon polymer, a polysulfone resin, a perfluorocarbon polymer having a phosphonic acid group or a carboxylic acid group, or the like. An example of the sulfonic acid type perfluorocarbon polymer is Nafion 112 (made by DuPont: registered trademark). Also, an example of the nonfluorine polymer is a sulfonated aromatic polyether ketone, polysulfone or the like. The thickness of the electrolyte membrane 312 is 10 to 200 μm, for instance.

The anode catalyst layers 314 of the membrane electrode assemblies 310 are disposed on one of the surfaces of the electrolyte membrane 312 spaced apart from each other. Also, the cathode catalyst layers 316 of the membrane electrode assemblies 310 are disposed on the other of the surfaces of the electrolyte membrane 312 spaced apart from each other. A membrane electrode assembly 310 (single cell) is composed of an electrolyte membrane 312 held between a pair of an anode catalyst layer 314 and a cathode catalyst layer 316. A variety of configurations and arrangements can be employed for the anode catalyst layer 314 and the cathode catalyst layer 316, provided that insulation between adjacent single cells is maintained to avoid short circuit.

Hydrogen is supplied to the anode catalyst layer 314 as fuel gas. Air is supplied to the cathode catalyst layer 316 as oxidant. Each of the MEAs 310 generates power through an electrochemical reaction between the hydrogen and the oxygen in the air.

The anode catalyst layer 314 and the cathode catalyst layer 316 are each provided with ionomer and catalyst particles or carbon particles as the case may be. The ionomer provided in the anode catalyst layer 314 and the cathode catalyst layer 316 may be used to promote adhesion between the catalyst particles and the electrolyte membrane 312. This ionomer may also play a role of transferring protons between the catalyst particles and the electrolyte membrane 312. The ionomer may be formed of a polymer material similar to that of the electrolyte membrane 312. A catalyst metal may be a single element or an alloy of two or more elements selected from among Sc, Y, Ti, Zr, V, Nb, Fe, Co, Ni, Ru, Rh, Pd, Pt, Os, Ir, lanthanide series element, and actinide series element. Furnace black, acetylene black, ketjen black, carbon nanotube or the like may be used as the carbon particle when a catalyst is to be supported. The thickness of the anode catalyst layer 314 and the cathode catalyst layer 316 may be from about 10 to 40 μm, for instance.

The interconnector 320, which is disposed between adjacent MEAs 310, constitutes part of an electric pathway from the anode catalyst layer 314 of one of the adjacent MEAs 310 to the cathode catalyst layer 316 of the other thereof. The interconnector 320 includes a conductor 322 and an insulator 324. The conductor 322 is so disposed as to penetrate the electrolyte membrane 312 in a position between adjacent MEAs 310. Provided between the conductor 322 and the electrolyte membrane 312 is the insulator 324, which prevents a short between the both members 322 and 312.

The current collecting member 330 includes a plurality of anode current collectors 332 and a plurality of cathode current collectors 334. The plurality of anode current collectors 332 are disposed on the surface of their respective anode catalyst layers 314 and electrically coupled thereto. The plurality of cathode current collectors 334 are disposed on the surface of their respective cathode catalyst layers 316 and electrically coupled thereto. An end of the anode current collector 332 connected to the anode catalyst layer 314 of one of adjacent MEAs 310 extends to the interconnector 320 disposed between the adjacent MEAs 310 and is electrically coupled to one end of the conductor 322 of this interconnector 320. Also, an end of the cathode current collector 334 connected to the cathode catalyst layer 316 of the other of the adjacent MEAs 310 extends to the same interconnector 320 and is electrically coupled to the other end of the conductor 322 of this interconnector 320. The plurality of MEAs 310 arranged in a plane are connected in series with each other via the anode current collectors 332, the cathode current collectors 334, and the conductors 322 of the interconnectors 320. Gold mesh, carbon paper, or carbon cloth, for instance, may be used as the anode current collectors 332 and the cathode current collectors 334. The width of the interconnector 320 may be in the range of about 30 to 300 μm, for instance.

The anode housing 340 is a lid member provided on an anode catalyst layer 314 side of the MEAs 310. Formed between the anode housing 340 and the anode catalyst layers 314 are a plurality of terminal hydrogen flow paths 342 in positions corresponding to the respective MEAs 310. The terminal hydrogen flow paths 342 are each so arranged as to extend in the same direction as the extension direction of the MEAs 310. Also provided in the anode housing 340 is a hydrogen flow path 344. The hydrogen flow path 344 runs in a direction intersecting with the extension direction of the terminal hydrogen flow paths 342, and one end thereof is communicated with the hydrogen supply path of the regulator unit 200. Also, all the terminal hydrogen flow paths 342 are connected at one end thereof to the hydrogen flow path 344.

The hydrogen discharged from the first to third containers 110, 120 and 130 of the fuel containing unit 100 reaches the hydrogen flow path 344 after passing through the piping unit 500 and the regulator unit 200, and then it is supplied to the anode catalyst layers 314 of the MEAs 310 by passing through the terminal hydrogen flow paths 342 branching off from the hydrogen flow path 344.

The cathode housing 350 is a lid member provided on a cathode catalyst layer 316 side of the MEAs 310. Formed in the cathode housing 350 are a plurality of air inlets 352 in positions corresponding to the respective MEAs 310, which are designed to introduce air as the oxidant from outside. Provided on the outside of the cathode housing 350 is a mesh cathode filter 354 in such a manner as to cover the air inlets 352. The cathode filter 354 removes grit and dust from the air entering through the air inlets 352. The air from the outside is sent inside the fuel cells 300 through the cathode filter 354 and the air inlets 352 and supplied to the cathode catalyst layers 316 of the MEAs 310.

The material used for the anode housing 340 and the cathode housing 350 may be a commonly-used plastic resin such as phenol resin, vinyl resin, polyethylene resin, polypropylene resin, polystyrene resin, urea resin or fluororesin.

The operation display unit 400 can display such information as temperature, pressure, remaining amount of hydrogen within the fuel containing unit 100. The detected values of temperature sensors, such as temperature sensors 610a and 610b, pressure sensors, and remaining hydrogen indicators may be sent via the control unit 600 or directly to the operation display unit 400, where those detected values are displayed. The operation display unit 400 may also be provided with various operation switches. As these operation switches are operated, control signals corresponding to the operation of the switches are sent from the operation display unit 400 to the control unit 600. Also, the operation display unit 400 may have a communication connector, so that it may be connected with the hydrogen filling unit via a communication cable plugged to the communication connector. Thus the operation display unit 400 can transmit such information as temperature, pressure, remaining amount of hydrogen within the fuel containing unit 100 to the hydrogen filling unit.

The control unit 600 carries out various controls of the fuel cell system 1 including the operation start and stop of the fuel cells 300. The control unit 600 can recognize the state of operation of the fuel cells 300 by receiving status signals therefrom. Also, in the present embodiment, the control unit 600 controls the discharge regulating valve 538 according to the temperature information on the interior of the third container 130 obtained from the temperature sensors 610a and 610b.

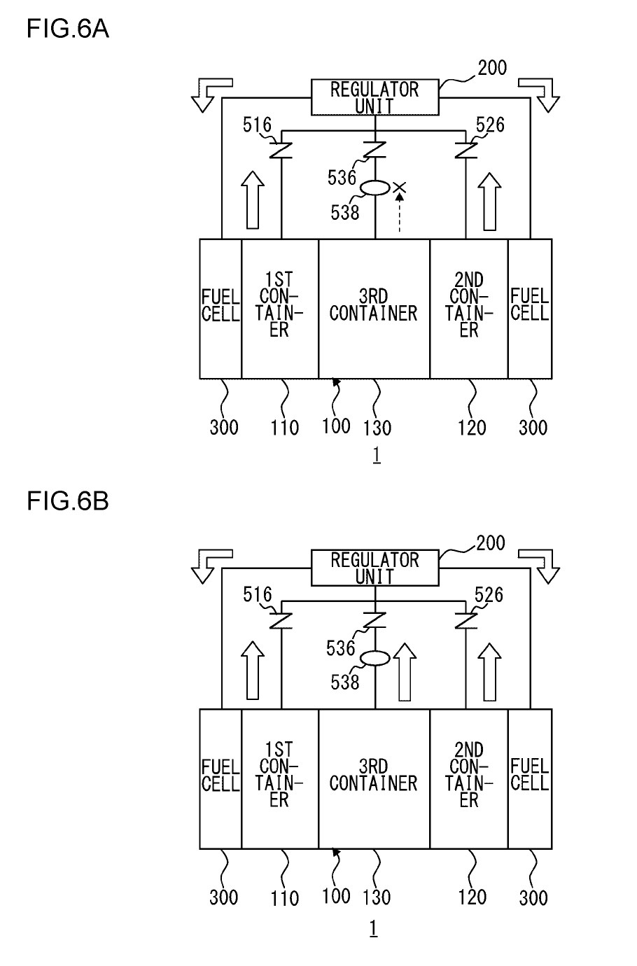

Now a description will be given of an example of operation control for the fuel cell system 1 implementing the above-described structure. FIGS. 6A and 6B are schematic diagrams for explaining an operation control for the fuel cell system according to the first embodiment. FIG. 6A shows the flows of hydrogen when the discharge regulating valve 538 is in a suppressed state, whereas FIG. 6B shows the flows of hydrogen when the discharge regulating valve 538 is in an open state.

In the fuel cell system, heat generated by an electrochemical reaction at the fuel cells is transferred to the fuel containing unit. Then the interior of the fuel containing unit warmed by this heat promotes the discharge of hydrogen from the metal hydride in the fuel containing unit. In the initial phase of operation of the fuel cells, the interior of the fuel containing unit is generally cool, and it is the outer region adjacent to the fuel cells where the temperature begins to rise first. Then, with heat transfer from the outer region, the temperature in the central region of the fuel containing unit 100 begins to rise later than in the outer region.

The temperature in the outer region of the fuel containing unit 100 rises in a short time due to the heat transfer from the fuel cells 300, so that the equilibrium pressure can be maintained high. Contrary to this, the temperature rise in the central region of the fuel containing unit 100 is slow because there is less heat supply than in the outer region. Hence, the temperature rise in the central region can be hampered by the discharge of hydrogen, which is an endothermic reaction, even when a little rise in temperature of the central region has started a hydrogen discharge from the metal hydride. Consequently, it is difficult to maintain the equilibrium pressure in the central region sufficiently high. As a result, the rate of hydrogen discharge in the central region of the fuel containing unit is lower than that in the outer region thereof, such that it is difficult to quickly stabilize the rate of hydrogen supply from the fuel containing unit as a whole to the fuel cells. In particular, if a large fuel containing unit is employed so as to increase its hydrogen content, it will take a long time before the hydrogen can be supplied steadily to the fuel cells.

To solve this problem, the fuel cell system of the present embodiment, as shown in FIGS. 6A and 6B, is configured such that the fuel containing unit 100 is held between a pair of fuel cells 300, and the fuel containing unit 100 is composed of the first container 110 and the second container 120, which correspond to the outer regions of the conventional fuel cell unit, and the third container 130, which corresponds to the central region thereof. Moreover, the discharge regulating valve 538 is disposed in the flow path connecting the third container 130 to the regulator unit 200. And when the temperature inside the third container 130 is below a predetermined temperature, hydrogen discharge from the third container 130 is suppressed as shown in FIG. 6A, and when it rises to or above the predetermined temperature, the suppression of hydrogen discharge from the third container 130 is canceled as shown in FIG. 6B.

The control unit 600 performs control as follows. That is, the discharge regulating valve 538 is controlled according to the information obtained from the temperature sensors 610a and 610b such that the discharge regulating value 538 is in a suppressed state when the temperature inside the third container 130 is less than the predetermined temperature, and the discharge regulating valve 538 is in an open state when the temperature inside the third container 130 is greater than or equal to the predetermined temperature. Thus, hydrogen discharge from the third container 130 is hampered while the temperature within the third container 130 is low, so that hydrogen discharge from the metal hydride is suppressed. As a result, the temperature drop inside the third container 130 can be prevented and therefore the temperature inside the third container 130 rises. When the temperature inside the third container 130 rises to or above the predetermined temperature, the equilibrium pressure is less likely to drop even though the hydrogen discharge from the metal hydride develops further. This is because there is a sufficient amount of heat required for hydrogen discharge of the metal hydride. Hence, the suppression of hydrogen discharge from the third container 130 can be canceled. Note that the “predetermined temperature” may be set, as appropriate, based on the data obtained through experiments or simulation runs carried out by a designer.

While hydrogen discharge from the third container 130 is being suppressed, the hydrogen discharged from the first container 110 and the second container 120 is supplied to the fuel cells 300. When the temperature inside the third container 130 rises to or above the predetermined temperature and thereby hydrogen can be discharged from the third container 130, the hydrogen discharged from the third container 130 is supplied to the fuel cells 300 in addition to the hydrogen discharged from the first container 110 and the second container 120.

In the present embodiment, the third container 130 is larger in volumetric capacity than the first container 110 and the second container 120. Thus, the temperature of the first container 110 and the second container can be raised in a shorter time, as compared with the case where the volumetric capacity of the third container 130 is less than or equal to that of the first container 110 and the second container 120. Hence, the rate of hydrogen discharged from the first container 110 and the second container 120 can be increased to a required level in a shorter time. As a result, the time required for start-up of the fuel cell system 1 can be reduced.

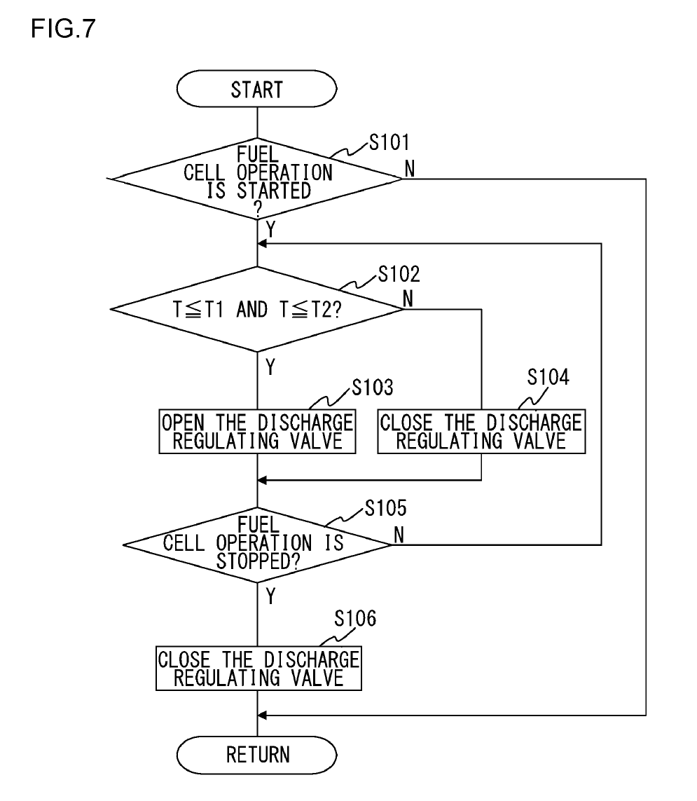

FIG. 7 is a flowchart for controlling the fuel cell system 1 according to the first embodiment. In the flowchart of FIG. 7, the procedure of each structural component is shown using S (the capital letter of “Step”), which means a step, and numbers combined. If a determining process is executed in a processing indicated by the combination of S and a number and if the decision result is positive, “Y” (the capital letter of “Yes”) will be appended like “Y of S10”. If, on the other hand, the decision result is negative, “N” (the capital letter of “No”) will be appended like “N of S10”. Such a flow is repeated by the control unit 600 with predetermined timing after the power-on of the fuel cell system 1.

The control unit 600 first determines whether the operation of the fuel cells 300 is started or not (S101). If the operation of the fuel cells 300 is not started (N of S101), the control unit 600 will terminate this routine. If the operation of the fuel cells 300 is started (Y of S101), the control unit 600 will determine if a wall surface temperature T1 of the partition 103 is greater than or equal to a predetermined temperature T and a wall surface temperature T2 of the partition 104 is greater than or equal to the predetermined temperature T, based on the information obtained from the temperature sensors 610a and 610b (S102).

If both the wall surface temperature T1 and the wall surface temperature T2 are greater than or equal to the predetermined temperature T (Y of S102), the control unit 600 will open the discharge regulating value 538 so as to set it in an open state (S103). If, on the other hand, at least one of the wall surface temperature T1 and the wall surface temperature T2 is less than the predetermined temperature T (N of S102), the control unit 600 will close completely or partially the discharge regulating value 538 so as to set it in a suppressed state (S104). Thereafter, the control unit 600 determines if the operation of the fuel cells 300 has stopped (S105).

If the operation of the fuel cells 300 has not yet stopped (N of S105), the control unit 600 will return to Step S102 and determine if both the wall surface temperature T1 and the wall surface temperature T2 are greater than or equal to the predetermined temperature T (S102). If the operation of the fuel cells 300 has stopped (Y of S105), the control unit 600 will close the discharge regulating value 538 so as to set it to a suppressed state in preparation for the next start-up (S106) and terminate this routine.

As described above, the fuel cell system 1 according to the present embodiment has the fuel containing unit 100, which is divided into the first to third containers, and a pair of fuel cells 300 which are disposed such that the fuel containing unit 100 is interposed between the pair of fuel cells 300. Also, the fuel cell system 1 has the discharge regulating valve 538 which is used to adjust the rate of hydrogen discharged from the third container 130 disposed between the first container 110 and the second container 120. The control unit 600 suppresses hydrogen discharge from the third container 130 when the temperature inside the third container 130 is below the predetermined temperature, and cancels the suppression of hydrogen discharge from the third container 130 when it rises to or above the predetermined temperature. Thus, even in a state, such as at an early stage of the operation of the fuel cells 300, where the interior of the fuel containing unit 100 is not sufficiently warmed, the drop in the equilibrium pressure in the third container 130 can be prevented. Thereby, hydrogen can be stably supplied to the fuel cells.

### Second Embodiment

A fuel cell system according to a second embodiment further includes a structure by which hydrogen is supplied from the third container 130 to the first container 110 and the second container 120 after an operation of the fuel cells has stopped. A description is now given of the second embodiment. The structural components other than a piping unit 500 of a fuel cell system 1 is basically the same as those of the first embodiment. The components identical to or equivalent to those of the first embodiment are given the same reference numerals, and the repeated explanation thereof is omitted as appropriate.

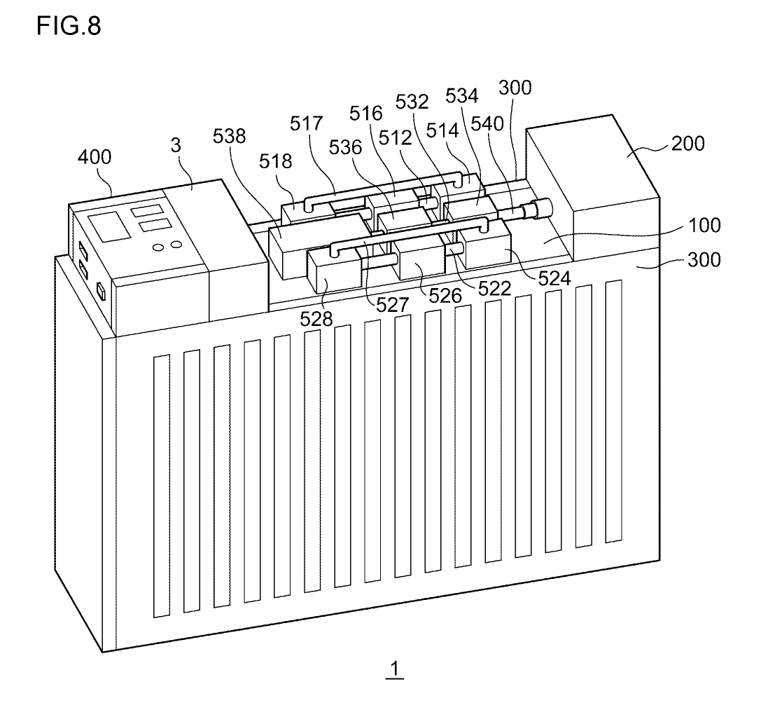

FIG. 8 is a schematic perspective illustration of the fuel cell system according to the second embodiment with a control unit and a piping unit cover both removed. The piping unit in the fuel system 1 according to the second embodiment has pipings 512, 522 and 532, which extend parallel to each other, and a collecting pipe 540. The pipings 512, 522 and 532 constitute flow paths for hydrogen sent out from the first container 110, the second container 120, and the third container 130, respectively. The pipings 512 and 522 are provided along the way with joints 514 and 524, respectively. The pipings 512 and 522 extend toward the piping 532 via the joints 514 and 524, respectively. A joint 534 is provided at an end of the piping 532. Connected to the joint 534 are the pipings 512 and 522 and one end of the collecting pipe 540. The pipings 512, 522 and 532 are provided midway with check valves 516, 526 and 536, respectively. Also, the piping 532 is provided midway with a discharge regulating valve 538 on the side closer to the third container 130 than the check valve 536.

Also, the piping unit 500 of the second embodiment further includes bypass pipings 517 and 527 and flow path switching valves 518 and 528. The bypass piping 517 is a piping used to pass outside the check valve 516 of the piping 512. One end of the bypass piping 517 is connected via the joint 514 on the side closer to the collecting pipe 540 than the check valve 516 of the piping 512; the other end of the bypass piping 517 is connected via the flow path switching valve 518 on the side closer to the first container 110 than the check value 516 of the piping 512. The flow path switching valve 518 is a three-way valve, for instance, and may be provided at a position midway on the piping 512 so that the piping 512 can be connected to the other end of the bypass piping 517. The flow path switching valve 518 is configured such that the flow of hydrogen from the first container 110 to the regulator unit 200 via the check valve 516 and the flow of hydrogen from the third container 130 to the first container 110 via the bypass piping 517 are switchable.

Similarly, the bypass piping 527 is a piping used to pass outside the check valve 526 of the piping 522. One end of the bypass piping 527 is connected via the joint 524 on the side closer to the collecting pipe 540 than the check valve 526 of the piping 522; the other end of the bypass piping 527 is connected via the flow path switching valve 528 on the side closer to the second container 120 than the check value 526 of the piping 522. The flow path switching valve 528 is a three-way valve, for instance, and may be provided at a position midway on the piping 522 so that the piping 522 can be connected to the other end of the bypass piping 527. The flow path switching valve 528 is configured such that the flow of hydrogen from the second container 120 to the regulator unit 200 via the check valve 526 and the flow of hydrogen from the third container 130 to the second container 120 via the bypass piping 527 are switchable.

The fuel cell system 1 includes a distribution flow path for supplying hydrogen from the third container 130 to the first container 110 and the second container 120. In the second embodiment, the bypass pipings 517 and 527 constitute principal parts of this distribution flow path. Also, the fuel cell system 1 includes a flow path switch for switching between a main flow path for supplying hydrogen from the third container 130 to the fuel cells 300 and the distribution flow path. In the second embodiment, the piping 532 and the collecting pipe 540 constitute principal parts of the main flow path. Also, the regulator unit 200 and the flow path switching valves 518 and 528 constitute the flow path switch.

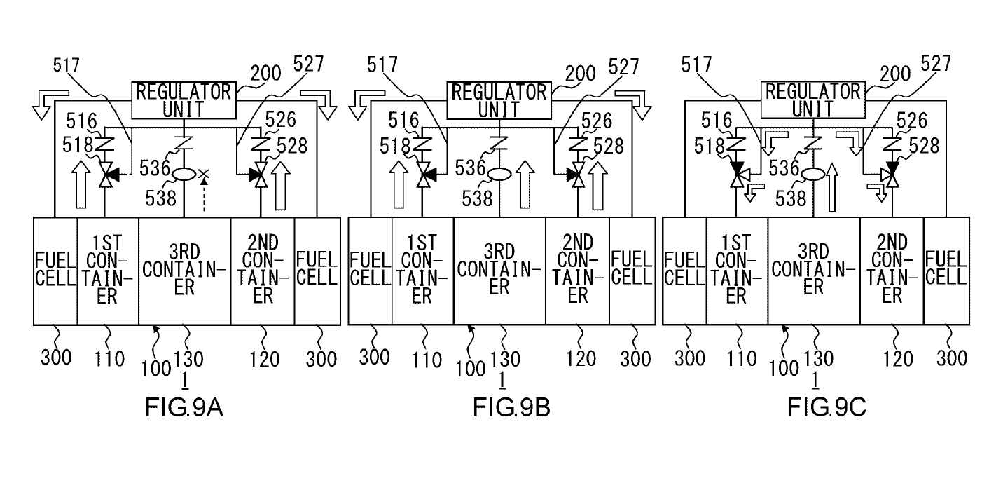

A description is now given of an exemplary operation control of the fuel cell system employing the above-described structure. FIGS. 9A to 9C are conceptual diagrams to explain an operation control of the fuel cell system according to the second embodiment. FIG. 9A illustrates a flow of hydrogen when the operation of the fuel cells 300 has started and the discharge regulating valve 538 is in a suppressed state. FIG. 9B illustrates a flow of hydrogen when the operation of the fuel cells 300 has started and the discharge regulating valve 538 is in an open state. FIG. 9C illustrates a flow of hydrogen when the operation of the fuel cells 300 has stopped.

As shown in FIG. 9A, when the temperature inside the third container 130 is below a predetermined temperature, the control unit 600 sets the discharge regulating valve 538 in a suppressed state and suppresses hydrogen discharge from the third container 130. As shown in FIG. 9B, when the temperature inside the third container 130 rises to or above the predetermined temperature, the control unit 600 sets the discharge regulating valve 538 in an open state and cancels the suppression of hydrogen discharge from the third container 130. Thus, even in a state, such as at an early stage of the operation of the fuel cells 300, where the interior of the fuel containing unit 100 is not sufficiently warmed, the drop in the equilibrium pressure in the third container 130 can be prevented. Thereby, hydrogen can be stably supplied to the fuel cells.

As shown in FIG. 9C, after an operation of the fuel cells 300 has stopped, the control unit 600 controls the flow path switch in such a manner as to switch the flow path from the main flow path to the distribution flow path. In this manner, after the operation of the fuel cells 300 has come to a stop, the control unit 600 supplies hydrogen inside the third container 130 to the first container 110 and the second container 120. More specifically, after the operation of the fuel cells 300 has come to a stop, the hydrogen supply path of the regulator unit 200 is shut off and the flow path switching valves 518 and 528 are switched to a state where the bypass pipings 517 and 527 communicate with the pipings 512 and 522, respectively, while the discharge regulating valve 538 is left in an open state.

After an operation of the fuel cells 300 has stopped, the amount of heat transfer from the fuel cells 300 to the fuel containing unit 100 decreases and therefore the fuel cell containing unit 100 is gradually cooled. At this time, the temperature of the first container 110 and the second container 120 positioned outside starts to drop before the third container 130 positioned inside does. Thus, hydrogen discharge from the third container 130 lasts longer than hydrogen discharge from the first container 110 and the second container 120 does. Hence, switching the hydrogen flow path, as described above, from the main flow path to the distribution flow path allows hydrogen inside the third container 130 to be supplied to the first container 110 and the second container 120 via the distribution flow path.

The first container 110 and the second container 120 are smaller in volumetric capacity than the third container 130, and the first container and the second container 120 discharge hydrogen immediately after the start-up of the fuel cells 300. Thus, hydrogen in the first container 110 and the second container 120 are more likely to be consumed than that in the third container 130, and hydrogen is more likely to remain in the third container 130 than in the first container 110 and the second container 120.

Hence, distributing the hydrogen inside the container 130 to the first container 110 and the second container 120 by switching the flow path to the distribution flow path, as described above, allows the remaining amounts of hydrogen in the respective containers to be averaged. As a result, the shortage of hydrogen supply from the first container 110 and the second container 120 at the next start-up of the fuel cells 300 can be prevented, thereby supplying hydrogen more stably.

After the first to third containers 110, 120 and 130 have become an equilibrium state and the internal pressures of the first to third containers 110, 120 and 130 have been averaged, the control unit 600 controls the flow path switch in such a manner as to effect switching from the distribution flow path to the main flow path where a flow of hydrogen to the fuel cells 300 is shut off. In this manner, after the internal pressures of the first to third containers 110, 120 and 130 have been averaged, the control unit 600 stops the supply of hydrogen to the first container 110 and the second container 120. More specifically, as the control unit 600 recognizes through the values detected by the not-shown pressure sensors that the internal pressures of the first to third containers have been averaged, the control unit 600 switches the flow path switching valves 518 and 528 to a flow path state where hydrogen discharged from the first container 110 and the second container 120 flows toward the check valves 516 and 526, respectively. At this time, the hydrogen supply path of the regulator unit 200 is kept to be shut off. As a result, the hydrogen flow path is switched from the distribution flow path to the main flow path where the hydrogen flow path to the fuel cells 300 is shut off. Also, the control unit 600 sets the discharge regulating valve 538 to a suppressed state in preparation for the next start-up of the fuel cells 300. Note that the above-described averaging of the internal pressures may include not only a case where the internal pressure of each container is set equal but also a case where the difference between each container is within a predetermined range. The degree of averaging of the internal pressures may be set, as appropriate, through simulation runs or experiments carried out by a designer.

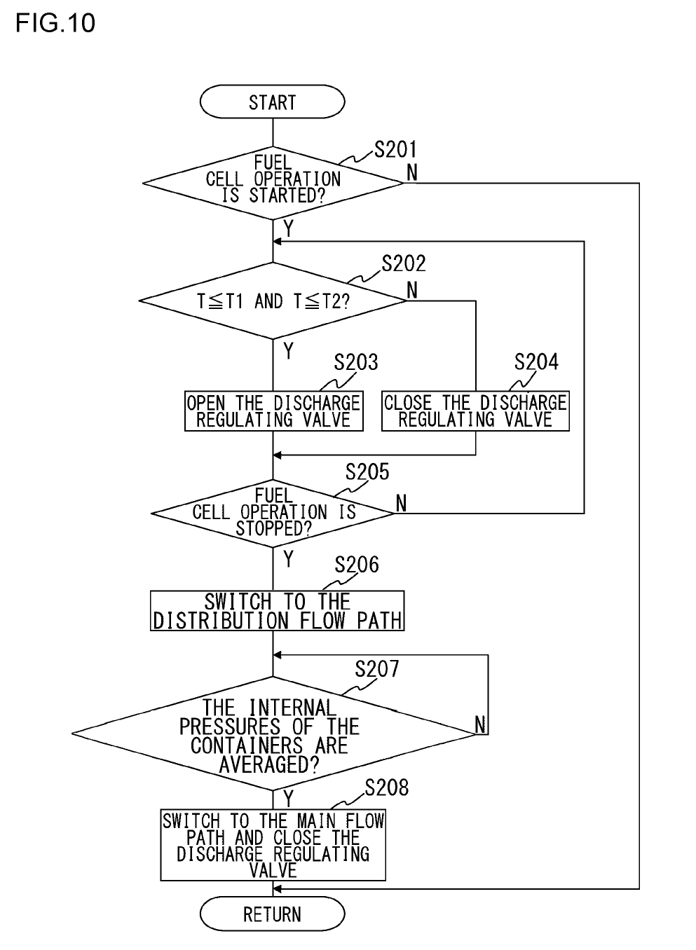

FIG. 10 is a flowchart for controlling the fuel cell system according to the second embodiment. This flow is repeated by the control unit 600 with predetermined timing after the power-on of the fuel cell system 1.

The control unit 600 first determines whether the operation of the fuel cells 300 is started or not (S201). If the operation of the fuel cells 300 is not started (N of S201), the control unit 600 will terminate this routine. If the operation of the fuel cells 300 is started (Y of S201), the control unit 600 will determine if the wall surface temperature T1 and the wall surface temperature T2 are greater than or equal to a predetermined temperature T, based on the information obtained from the temperature sensors 610a and 610b (S202).

If both the wall surface temperature T1 and the wall surface temperature T2 are greater than or equal to the predetermined temperature T (Y of S202), the control unit 600 will open the discharge regulating value 538 so as to set it in an open state (S203). If, on the other hand, at least one of the wall surface temperature T1 and the wall surface temperature T2 is less than the predetermined temperature T (N of S202), the control unit 600 will close completely or partially the discharge regulating value 538 so as to set it in a suppressed state (S204). Thereafter, the control unit 600 determines if the operation of the fuel cells 300 has stopped (S205).

If the operation of the fuel cells 300 has not yet stopped (N of S205), the control unit 600 will return to Step S202 and determine if both the wall surface temperature T1 and the wall surface temperature T2 are greater than or equal to the predetermined temperature T (S202). If the operation of the fuel cells 300 has stopped (Y of S205), the control unit 600 will switch the flow path to the distribution flow path (S206). Then, the control unit 600 determines if the internal pressures of the respective containers have been averaged (S207). The internal pressures thereof are not averaged (N of S207), the control unit 600 will repeat the determination of Step S207. If the internal pressures thereof have been averaged (Y of S207), the control unit 600 will switch the flow path from the distribution flow path to the main flow path and close the discharge regulating value 538 so as to set it to a suppressed state in preparation for the next start-up (S208) and terminate this routine.

As described above, in addition to the structural components of the fuel cell system 1 according to the first embodiment, the fuel cell system 1 according to the second embodiment includes (1) the distribution flow path for supplying hydrogen from the third container 130 to the first container 110 and the second container 120 and (2) the flow path switch for switching between the main flow path for supplying hydrogen from the third container 130 to the fuel cells 300 and the distribution flow path. Then, after an operation of the fuel cells 300 has stopped, the control unit 600 switches the flow path from the main flow path to the distribution flow path so as to supply the hydrogen inside the third container 130 to the first container 110 and the second container 120. As a result, the shortage of hydrogen supply from the first container 110 and the second container 120 at the next start-up of the fuel cells 300 can be prevented. Thereby, hydrogen can be further stably supplied to the fuel cells 300.

### Third Embodiment

Although in the above-described first and second embodiments a structure is such that the fuel containing unit 100 is interposed between a pair of fuel cells 300, there may be provided a single fuel cell only, instead. A description is given hereunder of a third embodiment. Note that the components identical to or equivalent to those of the first embodiment are given the same reference numerals, and the repeated explanation thereof is omitted as appropriate.

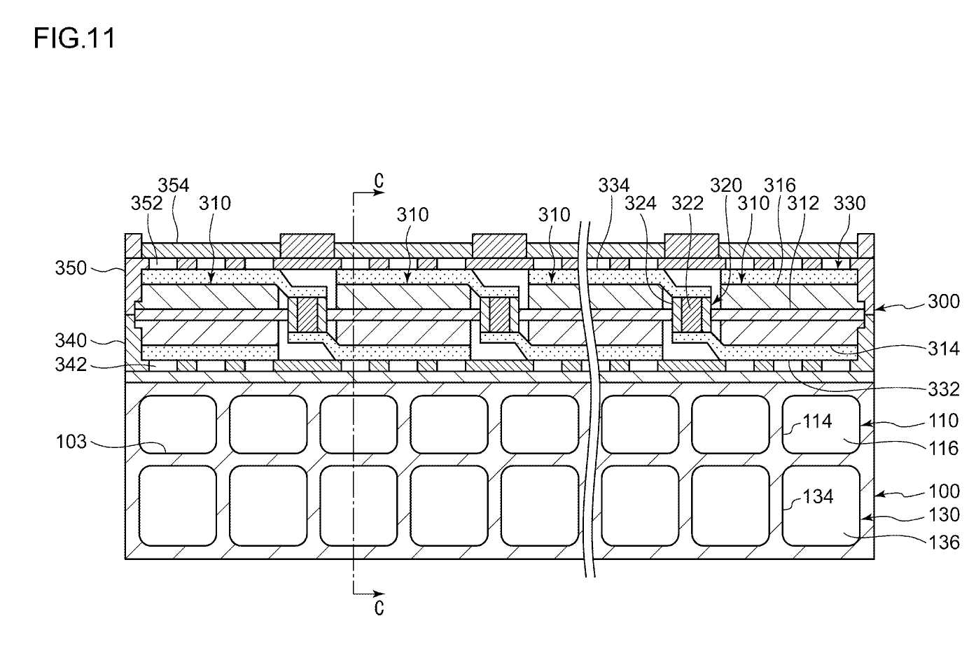

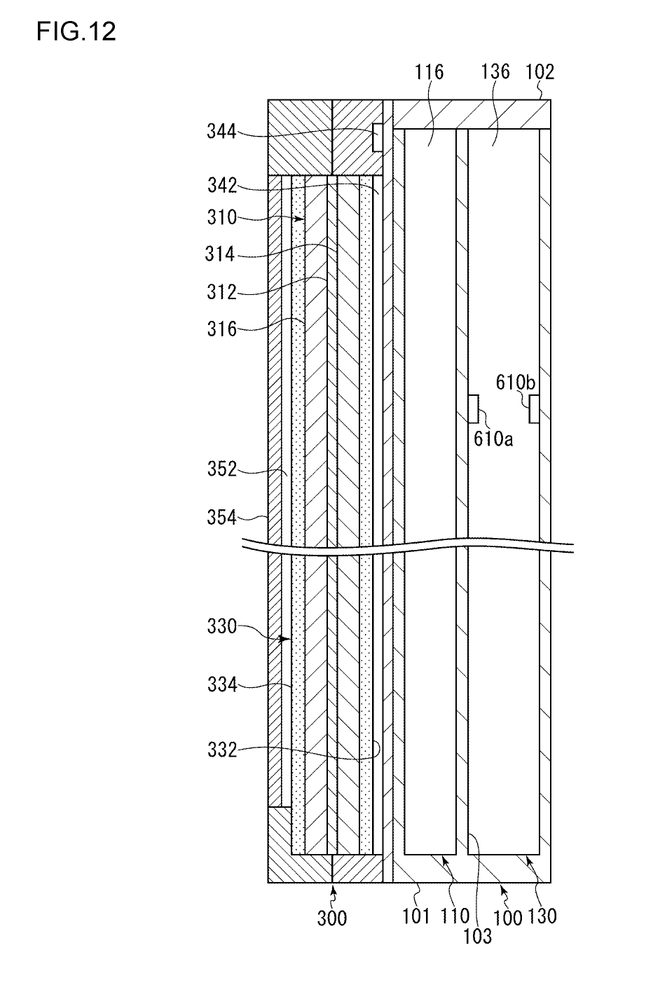

FIG. 11 is a horizontal sectional view schematically showing a structure of a fuel cell system according to the third embodiment. FIG. 12 is a vertical sectional view schematically showing a structure of the fuel cell system according to the third embodiment. FIG. 11 corresponds to FIG. 4 of the first embodiment. FIG. 12 corresponds to FIG. 5 of the first embodiment, and FIG. 12 is a cross-sectional view taken along the line C-C of FIG. 11. It is to be noted that the outer casing of the fuel cell system 1 is not shown in FIG. 11 and FIG. 12.

The fuel system 1 according to the third embodiment is configured such that the second container 120, the fuel cell 300 in contact with the main surface on the second container 120 side of the fuel containing unit 100, the piping 522 constituting the flow path for hydrogen sent out from the second container 120, and so forth are removed from the fuel cell system 1 of the first embodiment.

More specifically, as shown in FIG. 11 and FIG. 12, the fuel containing unit 100 (the fuel containers) in the fuel cell system 1 of the third embodiment includes a first container 110 (one of the containing unit) and a third container (the other of the containing unit). The first container 110 and the third container 130 are disposed in thermal contact with each other. In the third embodiment, a container section 101 has an interior divided into two chambers by a partition 103, and thereby one of the two chambers constitute the first container 110 and the other thereof the third container 130. The third container 130 is larger in volumetric capacity than the first container 110.

The fuel cell 300 is in contact with the main surface on the first container 110 side of the fuel containing unit 100. Thus, the fuel cell 300 is so arranged that the fuel cell 300 is in thermal contact with the container 110 of the fuel containing unit 100.

The hydrogen discharged from the first container 110 and the third container 130 of the fuel containing unit 100 reaches the hydrogen flow path 344 after passing through the piping unit 500 (See FIG. 3) and the regulator unit 200 (See FIG. 3), and then it is supplied to the anode catalyst layers 314 of the MEAs 310 by passing through the terminal hydrogen flow paths 342 branching off from the hydrogen flow path 344.

The piping 512 constituting the flow path for hydrogen sent out from the third container 130 is provided midway with a discharge regulating valve 538 (See FIG. 3). The control unit 600 (See FIG. 2) controls the discharge regulating valve 538 according to the temperature information on the interior of the third container 130 obtained from the temperature sensors 610a and 610b.

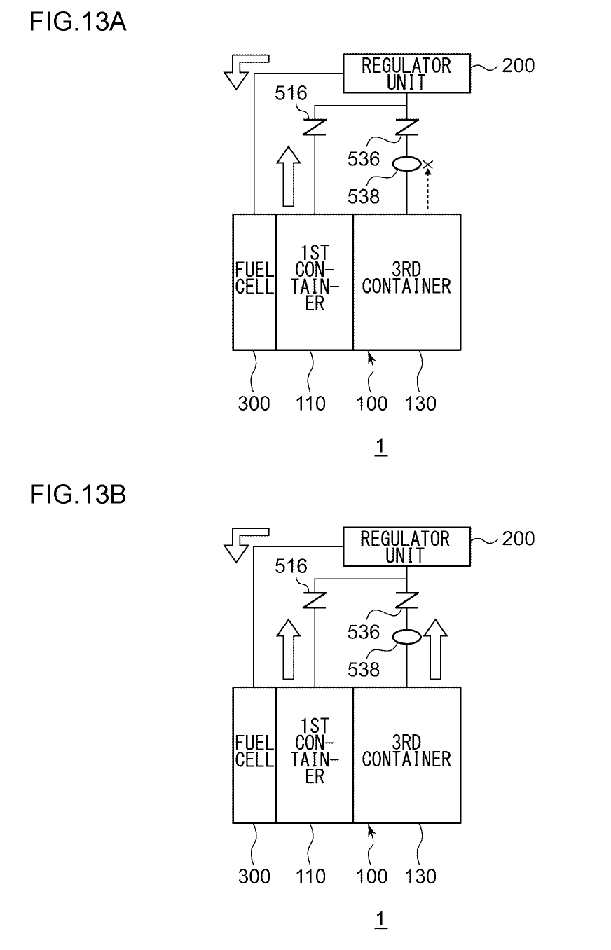

Now a description will be given of an example of operation control for the fuel cell system 1 implementing the above-described structure. FIGS. 13A and 13B are schematic diagrams for explaining an operation control for the fuel cell system according to the third embodiment. FIG. 13A shows the flows of hydrogen when the discharge regulating valve 538 is in a suppressed state, whereas FIG. 13B shows the flows of hydrogen when the discharge regulating valve 538 is in an open state.

As shown in FIG. 13A and FIG. 13B, in the fuel cell system 1 of the third embodiment, the fuel cell 300 is in contact with one of the main surfaces of the fuel containing unit 100, and the interior of the fuel containing unit 100 is divided into the first container on the side closer to the fuel cell 300 and the third container 130 on the side far from the fuel cell 300. Also, the discharge regulating valve 538 (See FIG. 3) is disposed in the flow path (See FIG. 3) connecting the third container 130 to the regulator unit 200.

As shown in FIG. 13A, when the temperature inside the third container 130 is below a predetermined temperature, the control unit 600 sets the discharge regulating valve 538 in a suppressed state and suppresses hydrogen discharge from the third container 130. As shown in FIG. 13B, when the temperature inside the third container 130 rises to or above the predetermined temperature, the control unit 600 sets the discharge regulating valve 538 in an open state and cancels the suppression of hydrogen discharge from the third container 130.

Thus, hydrogen discharge from the third container 130 is hampered while the temperature within the third container 130 is low, so that hydrogen discharge from the metal hydride is suppressed. As a result, the temperature drop inside the third container 130 can be prevented and therefore the temperature inside the third container 130 rises. When the temperature inside the third container 130 rises to or above the predetermined temperature, the equilibrium pressure is less likely to drop even though the hydrogen discharge from the metal hydride develops further. Hence, the suppression of hydrogen discharge from the third container 130 can be canceled. Note that the “predetermined temperature” may be set, as appropriate, based on the data obtained through experiments or simulation runs carried out by the designer.

While hydrogen discharge from the third container 130 is being suppressed, the hydrogen discharged from the first container 110 is supplied to the fuel cells 300. When the temperature inside the third container 130 rises to or above the predetermined temperature and thereby hydrogen can be discharged from the third container 130, the hydrogen discharged from the third container 130 is supplied to the fuel cells 300 in addition to the hydrogen discharged from the first container 110. The flow for controlling the fuel cell system 1 is similar to that of the first embodiment and therefore the repeated description is omitted here.

In the present embodiment, the third container 130 is larger in volumetric capacity than the first container 110. Thus, the temperature of the first container 110 can be raised in a shorter time, as compared with the case where the volumetric capacity of the third container 130 is less than or equal to that of the first container 110. Hence, the rate of hydrogen discharged from the first container 110 can be increased to a required level in a shorter time.

As described above, the fuel cell system 1 according to the third embodiment has the fuel containing unit 100, which includes the first container 110 and the third container 130 disposed in thermal contact with each other, and the fuel cell 300 disposed in contact with the first container 110. Also, the fuel cell system 1 has the discharge regulating valve 538 used to adjust hydrogen discharge from the third container 130 located away from the fuel cell 300. The control unit 600 suppresses hydrogen discharge from the third container 130 when the temperature inside the third container 130 is below the predetermined temperature, and cancels the suppression of hydrogen discharge from the third container 130 when it rises to or above the predetermined temperature. Such a structure as in the third embodiment also enables the stable supply of hydrogen to the fuel cell.

The present invention is not limited to the above-described embodiments only, and it is understood by those skilled in the art that various modifications such as changes in design may be made based on their knowledge and the embodiments added with such modifications are also within the scope of the present invention.

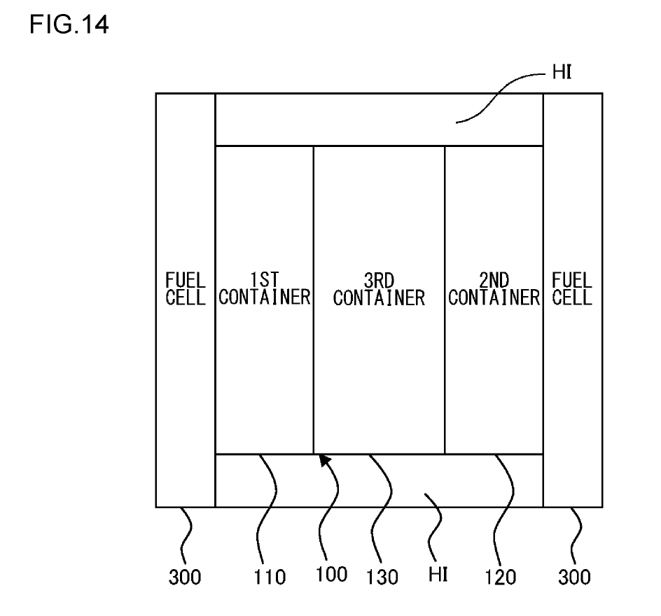

FIG. 14 is a conceptual diagram to explain a structure of a fuel cell system according to a modification. The fuel cell 300 and the first to third containers 110, 120 and 130 only are shown and the other components are omitted in FIG. 14. As shown in FIG. 14, the fuel cell system 1 according to this modification is configured such that the first container 110 and the second container 120 are in contact with a central part of the fuel cells 300 but are not in contact with a peripheral part of the fuel cells 300.

Heat is more likely to be lost to the exterior in the peripheral part of the fuel cells 300 than in the central part thereof. Accordingly, the temperature of the fuel cells 300 is more likely to increase in the central part than in the peripheral part. Thus, the first container 110 and the second container 120 are arranged such that they are in contact with only the central part of the fuel cells 300, so that the first container 110 and the second container 120 can be heated efficiently. Also, the surfaces of the fuel containing unit 100 except for regions in contact with the fuel cells 300 are covered with heat insulating materials HI, so that heat of the fuel cells 300 can be further efficiently transferred to the third container 130 through the first container 110 or the second container 120. It is to be noted here that the heat insulating material HI may not be provided at all. Also, the third container 130 may be in contact with a periphery of the fuel cell cells 300. This modification may be applicable to the third embodiment as well.

In each of the above-described embodiments, the control unit 600 controls the discharge regulating valve 538 using the temperature information on the interior of the third container 130 obtained from the temperature sensors 610a and 610b but this should not be considered as limiting. For example, the discharge regulating valve 538 may be controlled according to the time elapsed since the power-on of the fuel cells 300. A relation between the time elapsed after the power-on of the fuel cells 300 and the temperature variation inside the fuel cells 300 is measured beforehand, and thereby the temperature inside the third container 130 can be estimated using the elapsed time. In this case, a timer used to measure the elapsed time constitutes the temperature detecting unit.

In the above-described first and second embodiments, the interior of the fuel containing unit 100 is divided into three containers but it may be divided into four or more containers. In such a case, the discharge regulating valves may be provided in all of the containers except for the first container 110 and the second container 120. Also, in the above-described third embodiment, the interior of the fuel containing unit 100 is divided into two containers but it may be divided into three or more containers. In such a case, the discharge regulating valves may be provided in all of the containers except for the first container 110.

In the above-described second embodiment, hydrogen is supplied to both the first container 110 and the second container 120 but hydrogen may be supplied either one of them, instead. Also, although the distribution flow path is comprised principally of the piping 532 and the bypass pipings 517 and 527, an exclusive-use flow path, excluding the piping 532, which connects the third container 130 to at least one of the first container 110 and the second container 120 may be provided and therefore this exclusive-use flow path may serve as the distribution flow path.

The configuration of the above-described second embodiment may be applicable to the third embodiment. That is, a distribution flow path may be provided, so that hydrogen can be supplied from the third container 130 to the first container 110. Also, the above-described modification wherein the exclusive-use flow path excluding the piping 532 is provided as the distribution flow path may be applicable to the third embodiment.

In each of the above-described embodiments, the check valves 516, 526 and 536 are provided in the pipings 512, 522 and 532, respectively, which connect each container to the fuel cell(s) 300. Since hydrogen delivered from each container is consumed by the fuel cell(s) 300, it is highly improbable that hydrogen will flow backward from a fuel cell 300 side to the fuel containing unit 100. Thus, the check valves 516, 526 and 536 may not be provided at all.

If the temperature of the first container 110 or the second container 120 is high and the temperature of the third container 130 is low, it is possible that the hydrogen delivered from the first container 110 or the second container 120 may be supplied to the fuel cells 300 via the regulator unit 200 and, at the same time, flow into the third container 130. Accordingly, the check vale 536 may be provided in the piping 532 only. If no check valves 516 and 526 is provided in the first container 110 and the second container 120, the bypass pipings 517 and 527 and the flow path switching valves 518 and 528 can be omitted in the above-described second embodiment.

In this case, hydrogen is supplied to the first container 110 and/or the second container 120 from the third container 130 side after an operation of the fuel cells 300 has stopped. Also, in this case, the equilibrium pressure of hydrogen and the hydrogen storage ratio (the ratio of a hydrogen storage amount over the maximum hydrogen storage) become approximately equal in the first container 110, the second container 120 and the third container 130 (the first container 110 and the third container 130 in the third embodiment).

In each of the above-described embodiments, the third container 130 may be in thermal contact with the fuel cell(s) 300. In such a case, the amount of heat transfer from the fuel cell(s) 300 to the third container 130 is smaller than the amount of heat transfer from the fuel cell(s) 300 to the first container 110 and the second container 120 (from the fuel cell 300 to the first container 110 in the third embodiment).

What is claimed is:

1. A fuel cell system, comprising:
a fuel containing unit having at least two containers containing a metal hydride storing hydrogen to be supplied to a fuel cell, the two containers being disposed in thermal contact with each other;
a fuel cell disposed in thermal contact with one of the two containers;
a discharge regulating unit capable of switching between a suppressed state in which hydrogen discharge from the other of the two containers is suppressed and an open state in which the suppressed state is canceled; and
a control unit configured to control said discharge regulating unit according to information from a temperature detector for detecting temperature inside the other of the containers such that the suppressed state is set when the temperature inside the other container is less than a predetermined temperature and the open state is set when the temperature inside the other container is greater than or equal to the predetermined temperature.

2. A fuel cell system according to claim 1, wherein said fuel containing unit has at least a first to a third container, which are disposed such that the first container and the second container are in outermost positions with the third container disposed therebetween in thermal contact therewith,
wherein said fuel cell is a pair of fuel cells of which one is disposed in thermal contact with the first container and the other in thermal contact with the second container,
wherein said discharge regulating unit is capable of switching between the suppressed state in which hydrogen discharge from the third container is suppressed and the open state in which the suppressed state is canceled, and
wherein said control unit controls said discharge regulating unit according to information from a temperature detector for detecting temperature inside the third container such that the suppressed state is set when the temperature inside the third container is less than a predetermined temperature and the open state is set when the temperature inside the third container is greater than or equal to the predetermined temperature.

3. A fuel cell system according to claim 2, further comprising:
a distribution flow path configured to supply hydrogen from the third container to at least one of the first container and the second container; and
a flow path switch configured to switch between a main flow path for supplying hydrogen from the third container to the fuel cell and said distribution flow path,
wherein said control unit controls said flow path switch in such a manner as to effect switching from the main flow path to said distribution flow path after the stoppage of fuel cell operation.

4. A fuel cell system according to claim 3, wherein after the internal pressures of the first to third contains have been averaged, said control unit controls said flow path switch in such a manner as to effect switching from said distribution flow path to the main flow path where a flow of hydrogen to said fuel cell is cut off.

5. A fuel cell system according to claim 2, wherein the third container is larger in volumetric capacity than the first container and the second container.

6. A fuel cell system according to claim 3, wherein the third container is larger in volumetric capacity than the first container and the second container.

7. A fuel cell system according to claim 4, wherein the third container is larger in volumetric capacity than the first container and the second container.

8. A method for controlling a fuel cell system including (i) a fuel containing unit having at least two containers containing metal hydride storing hydrogen to be supplied to a fuel cell, the two containers being disposed in thermal contact with each other and (ii) a fuel cell disposed in thermal contact with one of the two container, wherein hydrogen discharge from the other of the two containers is suppressed when the temperature inside the other container is less than a predetermined temperature, and
the suppression of hydrogen discharge from the other of the two containers is canceled when the temperature inside the other container is greater than or equal to the predetermined temperature.

9. A method for controlling a fuel cell system including (i) a fuel containing unit having at least a first container to a third container containing a metal hydride storing hydrogen to be supplied to a fuel cell, which are disposed such that the first container and the second container are in outermost positions with the third container disposed therebetween in thermal contact therewith, and (ii) a pair of fuel cells of which one is disposed in thermal contact with the first container and the other in thermal contact with the second container, wherein hydrogen discharge from the third container is suppressed when the temperature inside the third container is less than a predetermined temperature, and
the suppression of hydrogen discharge from the third container is canceled when the temperature inside the third container is greater than or equal to the predetermined temperature.

10. A method for controlling a fuel system according to claim 9, wherein hydrogen is supplied from the third container to at least one of the first container and the second container after the stoppage of fuel cell operation.

11. A method, for controlling a fuel cell system, according to claim 10, wherein after the internal pressures of the first to third contains have been averaged, supplying hydrogen from the third container to at least one of the first container and the second container is stopped.
